(19) United States
(12) Patent Application Publication
(10) Pub. No.: US 2015/0136112 A1
(43) Pub. Date: May 21, 2015

(54) OUTDOOR COOKER

(71) Applicant: WABASH INDUSTRIAL SERVICES, LLC, WABASH, IN (US)

(72) Inventor: JEFFREY DONALD DYSON, WABASH, IN (US)

(21) Appl. No.: 14/539,625

(22) Filed: Nov. 12, 2014

Related U.S. Application Data
(60) Provisional application No. 61/952,442, filed on Mar. 13, 2014.
(60) Provisional application No. 61/904,705, filed on Nov. 15, 2013.

(51) Int. Cl. A47J 37/07

(52) U.S. Cl. CPC A47J 37/07
USPC 126/25 R

(57) ABSTRACT

An outdoor cooker with a fire pit standing on a plurality of legs. Multiple cooking devices can be pivotally connected with the fire pit and are movable between a position over the fire pit and a position away from the fire pit. For example, a cook top, a Shepard's hook for holding a pot, and/or a smoker box could be pivotally connected with the fire pit. In some embodiments, the pivotal connection between the fire pit and the cooking devices are transversely offset.

### RELATED APPLICATIONS

This present application is related to and claims priority to U.S. Provisional Patent Application Ser. No. 61/904,705 filed Nov. 15, 2013, entitled “Outdoor Cooker” and U.S. Provisional Patent Application Ser. No. 61/952,442 filed Mar. 13, 2014 entitled “Outdoor Cooker.” These applications are hereby expressly incorporated by reference in their entireties.

### TECHNICAL FIELD

The present disclosure generally relates to an outdoor cooker; in particularly, this disclosure relates to a fire pit structure with one or more cooking devices being attached to and movable over the pit.

### BACKGROUND AND SUMMARY

Outdoor cookers, such as propane and charcoal barbeque grills, are well known. These devices are popular for cooking various food products by putting the food on a grate above a heat source. Grills have limited flexibility on the types of food products that can be cooked simultaneously. For example, grills are not typically equipped with a way to cook food in a pot or kettle, such as a soup or chili, while also grilling meat, such as chicken or steaks. Although certain grills can be equipped with a smoker box, there is typically not a way to isolate some food in the smoker box while other food is grilled without smoke. Accordingly, there is a need for a device that provides more flexibility in the types of cooking devices that can be used to cook food.

According to one aspect, this disclosure relates to an outdoor cooker that includes a fire pit standing on a plurality of legs. The fire pit includes a first tube and a second tube that are axially offset with respect to each other. A first cooking device is provided that includes a post received in the first tube and is movably suspended between a first position over the fire pit and a second position away from the fire pit. The outdoor cooker includes a second cooking device with a post received in the second tube and movably suspended between a third position over the fire pit and a fourth position away from the fire pit.

In some embodiments, the outdoor cooker includes a first bracket attached to the post of the first cooking device and is configured to be selectively attached along the post of the first cooking device to adjust a height of the first cooking device with respect to the fire pit. Embodiments are contemplated in which the outdoor cooker has a second bracket attached to the post of the second cooking device, which allows height adjustment of the second cooking device. For example the first bracket and/or second bracket could include a set fastener for selectively interacting with the post of the first or second cooking device.

Depending on the circumstances, the first cooking device and/or second cooking device could include a handle that extends transversely with respect to the post of the cooking device. In some cases, the first cooking device is pivotably movable about the first tube between the first position and the second position. In some embodiments, the second cooking device is pivotably movable about the second tube between the third position and the fourth position. For example, the first cooking device and the second cooking device could pivot about axes that are offset from each other. In some cases, for example, the first tube and the second tube are disposed on approximately opposite sides of the fire pit. Embodiments are contemplated in which the cooking devices could be a cook top, such as a grill grate and a griddle, a Shepard's hook for holding a pot and/or a smoker box. In some cases, the smoker box includes a post pivotally connecting with the fire pit and a transversely extending handle.

According to another aspect, the disclosure provides an outdoor cooker with a fire pit standing on a plurality of legs. A first cooking device is pivotally connected with the fire pit between a first position over the fire pit and a second position away from the fire pit. A second cooking device is pivotally connected with the fire pit between a third position over the fire pit and a fourth position away from the fire pit. In some embodiments, the pivotal connection between the fire pit and the first cooking device is transversely offset from the pivotal connection between the fire pit and the second cooking device. Embodiments are contemplated in which the pivotal connection between the fire pit and the first cooking device is positioned on an approximately opposite side of the fire pit as the pivotal connection between the fire pit and the second cooking device. Depending on the circumstances, the first cooking device and the second cooking device are configured to simultaneously be disposed in the first position and the third position, respectively. For example, the first cooking device and the second cooking device could be approximately coaxial with fire pit when in the first position and the third position, respectively.

Additional features and advantages of the disclosure will become apparent to those skilled in the art upon consideration of the following detailed description of the illustrated embodiment exemplifying the best mode of carrying out the disclosure as presently perceived. It is intended that all such additional features and advantages be included within this description and be within the scope of the disclosure.

### BRIEF DESCRIPTION OF THE DRAWINGS

The present disclosure will be described hereafter with reference to the attached drawings which are given as non-limiting examples only, in which:

FIG. 1 is a perspective view of an example fire pit with multiple cooking devices attached;

FIG. 2 is a perspective view of the example fire pit shown in FIG. 1 with the cooktop suspended over the fire pit and the hook moved away from the fire pit;

FIG. 3 is a perspective view of the example fire pit shown in FIG. 1 with the cooktop and hook moved away from the fire pit;

FIG. 4 is a perspective view of the example fire pit shown in FIG. 1 with the cooktop suspended over the fire pit in a lower position;

FIG. 5 is a perspective view of the example fire pit shown in FIG. 4 with the cooktop suspended over the fire pit in a higher position;

FIG. 6 is a perspective view of the example fire pit shown in FIG. 1 with the hook suspended over the fire pit in a lower position;

FIG. 7 is a perspective view of the example fire pit shown in FIG. 6 with the hook suspended over the fire pit in a higher position;

FIG. 8 is a perspective view of an example hook that could be movably attached to the fire pit;

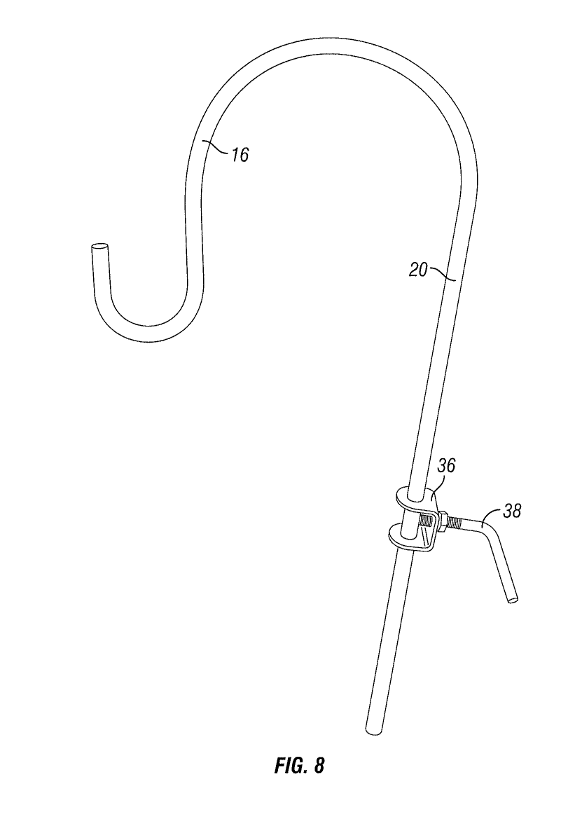

FIG. 9 is a perspective view of an example cooktop that could be movably attached to the fire pit;

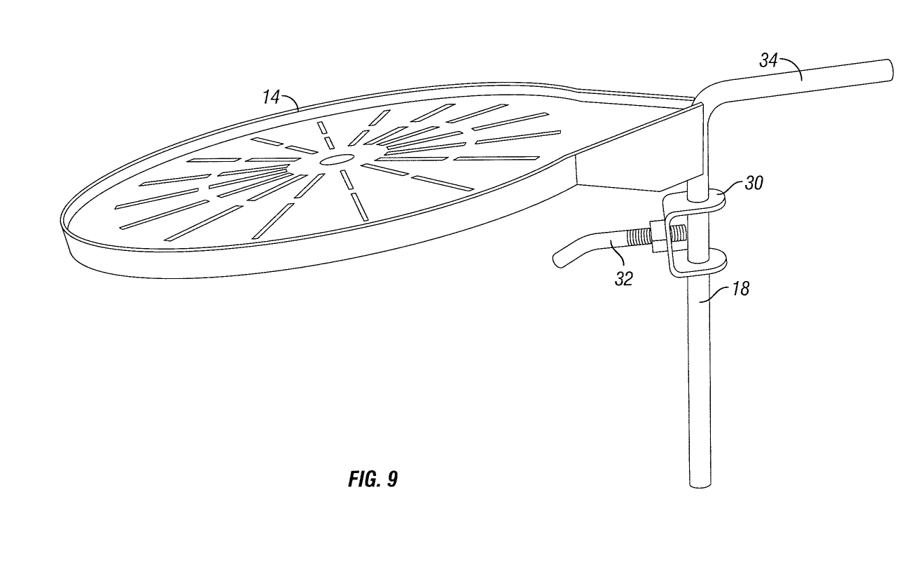

FIG. 10 is a detailed perspective view of an example bracket that could be used for attaching cooking devices to the fire pit;

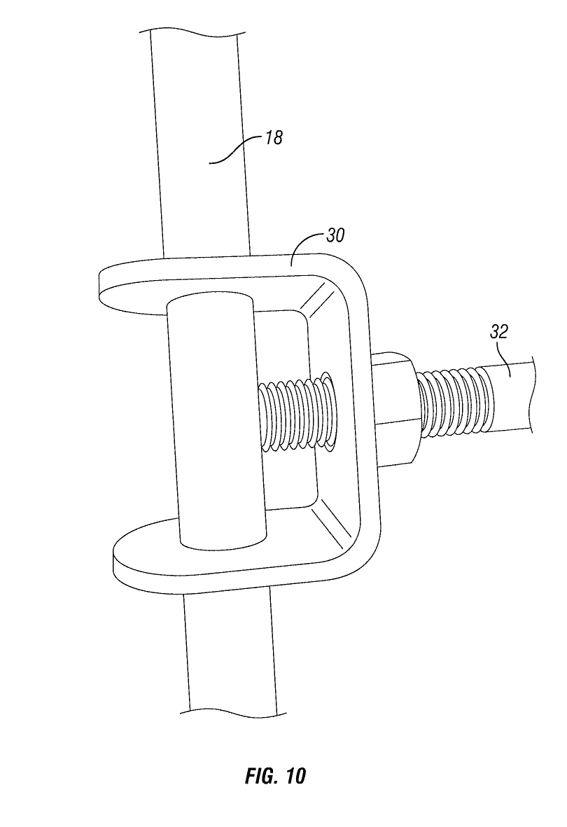

FIG. 11 is a perspective view of an example smoker box that could be used with the fire pit;

FIG. 12 is an exploded view of the example smoker box shown in FIG. 11; and

FIG. 13 is a perspective view of the example smoker box shown in FIG. 11 with the cover removed.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

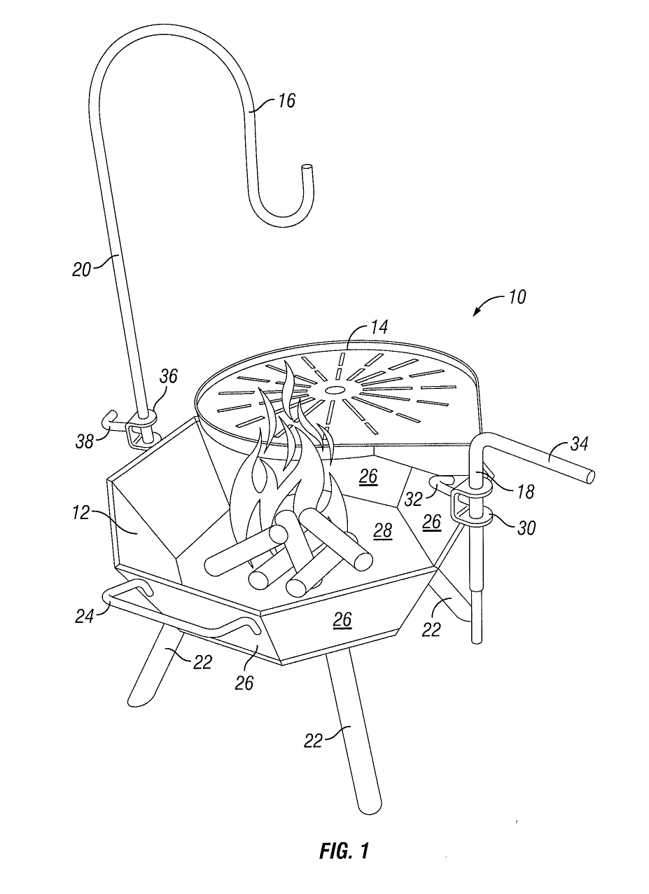

Referring to FIG. 1, this disclosure relates to an outdoor cooker 10 that uses a fire pit 12 with open flame to cook food on a cook top 14 and/or a Shepard's hook 16 that are/is suspended over the fire pit 12. The cook top 14 and Shepard's hook 16 may alternatively be removed from the pit 12 which can then be used as a standard fire pit. The open pit 12 is sized to hold charcoal or firewood. The cook top 14 and Shepard's hook 16 each include a rod 18, 20 that can be received in respective tubes mounted on opposing sides of the pit 12. This allows the cook top 14 and Shepard's hook 16 to be selectively pivoted toward or away from the fire.

In the embodiment shown, the outdoor cooker 10 includes the fire pit 12 standing on a plurality of legs 22 (illustratively 4). A handle 24 or handles may be attached to the side walls 26 of the fire pit 12 to assist in carrying the cooker 10. The pit 12 is configured to receive wood and/or charcoal and hold a fire to heat the cook top above. It is appreciated that the fire pit 12 can be appropriately sized so that it may adequately heat the cook top 14 but not be too large or too small to fail in that regard. In an illustrative embodiment, the base 28 of the fire pit 12 may be octagonal, round, or square with an illustrative diameter of about 18 inches. The sides 26 may extend upwardly either perpendicularly or at an angle (as shown) extending about 8 inches above the base 28. If the side walls 26 are flared as shown in FIG. 1, they create an illustrative top opening of about 26 inches. It is appreciated, however, that these dimensions are illustrative and may be varied to the extent they preserve the ability to cook on the cooking surface suspended above the pit.

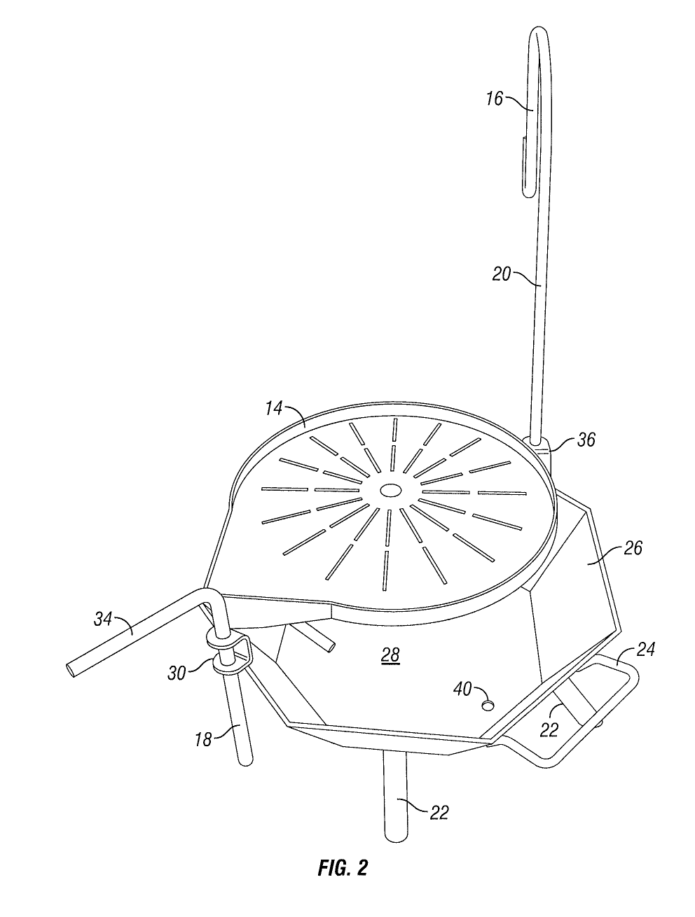

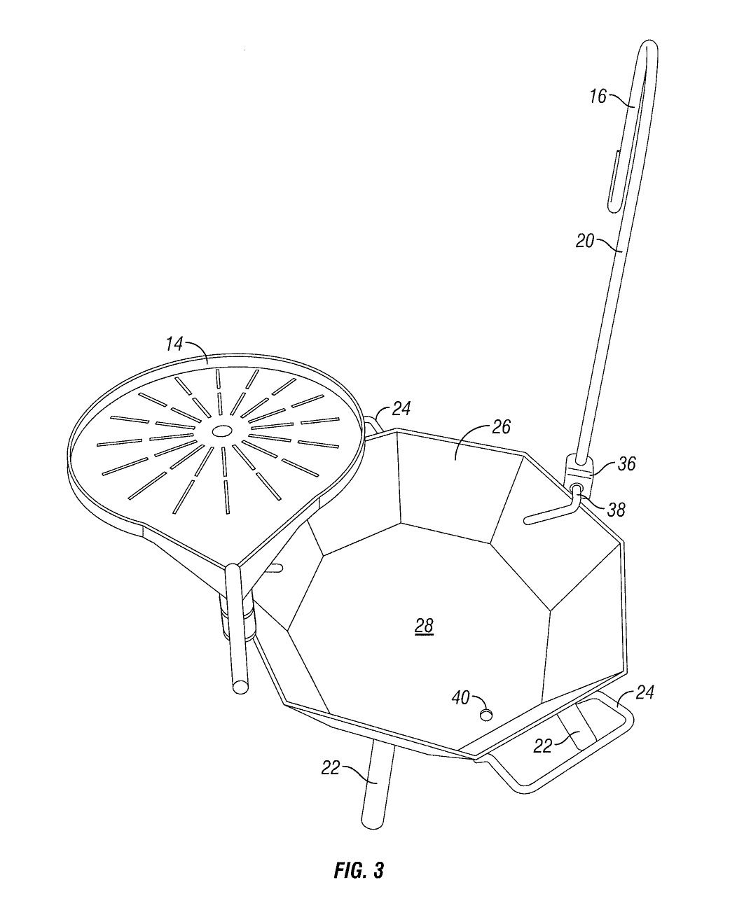

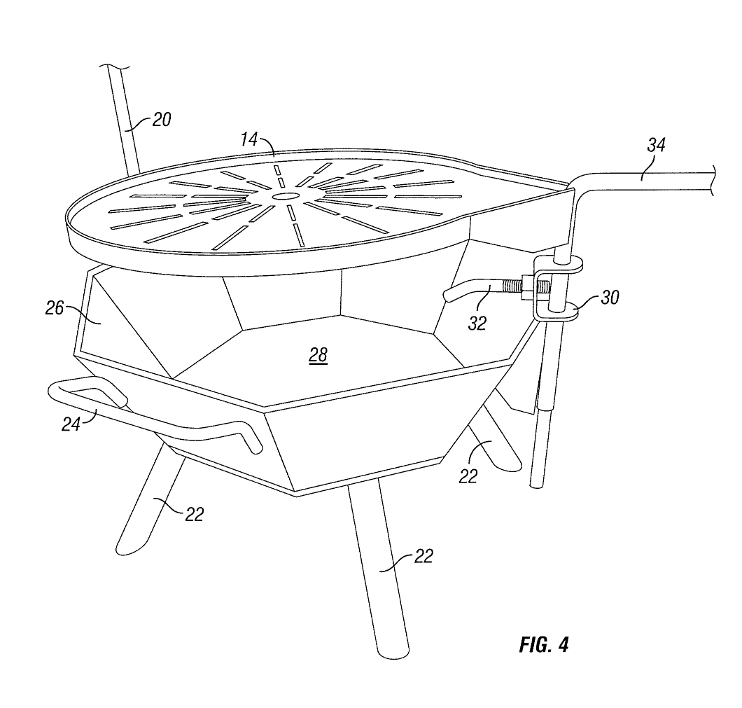

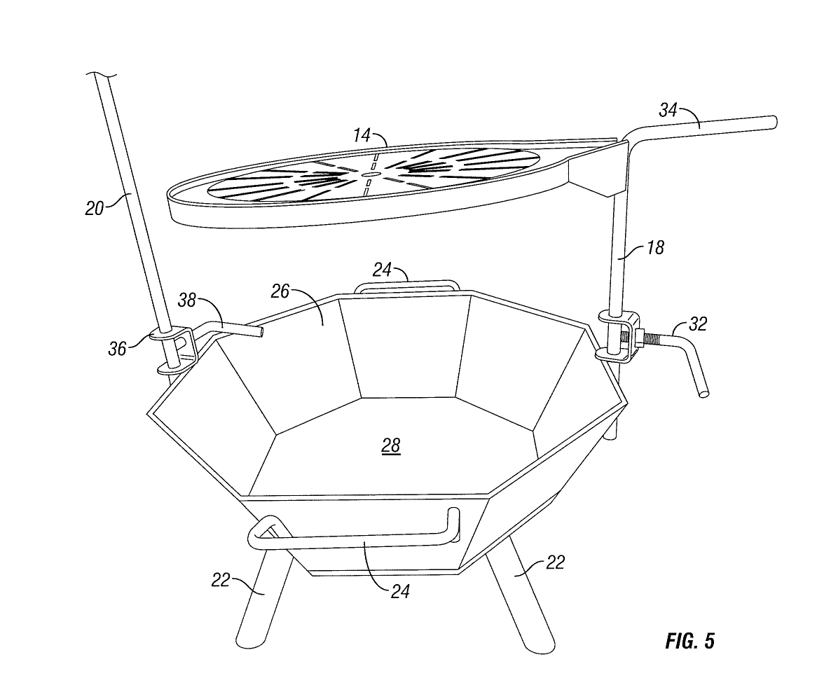

The cook top 14 that is movably suspended over the fire pit 12. In an illustrative embodiment, the cook top 14 such as a grill grate, griddle surface, or other-like surface, is suspendable over the fire pit 12. As shown, a rod 18 may extend vertically downward from the cook surface. The rod is illustratively located adjacent the outer periphery of the cook surface, making the cook surface configurable to be pivotable between over top of, or to the side off from, the fire pit 12. A lock bracket 30 as shown below may use a set fastener 32 to securely locate along the length of the downwardly-extending rod 18. This bracket 30 limits the length to which the rod can extend into the tube attached to the side of the fire pit 12. The lock bracket 30 is selectively adjustable along the rod 18 so as to determine the height above the fire pit 12 the cook surface pivots (See FIGS. 4 and 5). Additionally, a handle 34 may extend from the cook surface to ease pivoting the cook surface between (FIG. 1), over (FIG. 2) and off (FIG. 3) the flame in the fire pit. In the embodiments shown, when the cook surface is over the fire pit, the handle 34 is not located over the fire pit 12. This lessens any heat transfer from the fire pit 12 to the handle 34.

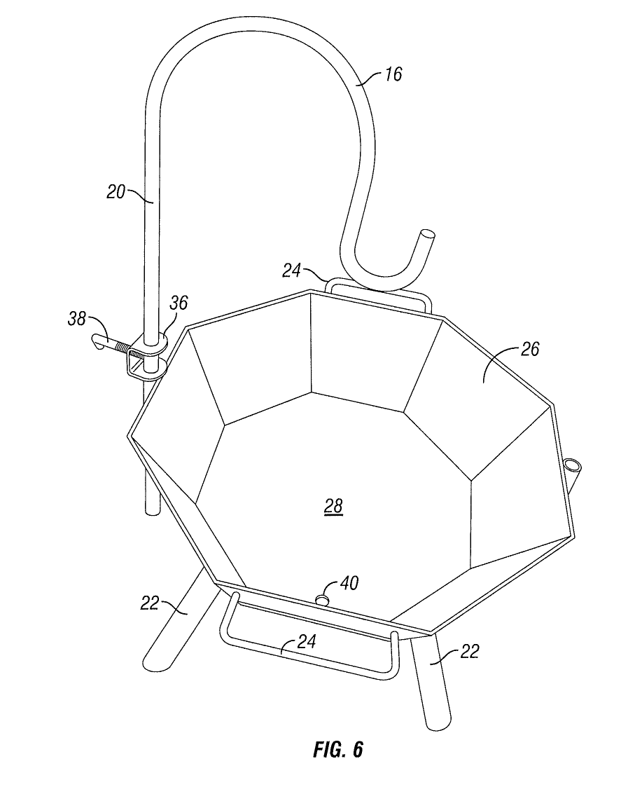

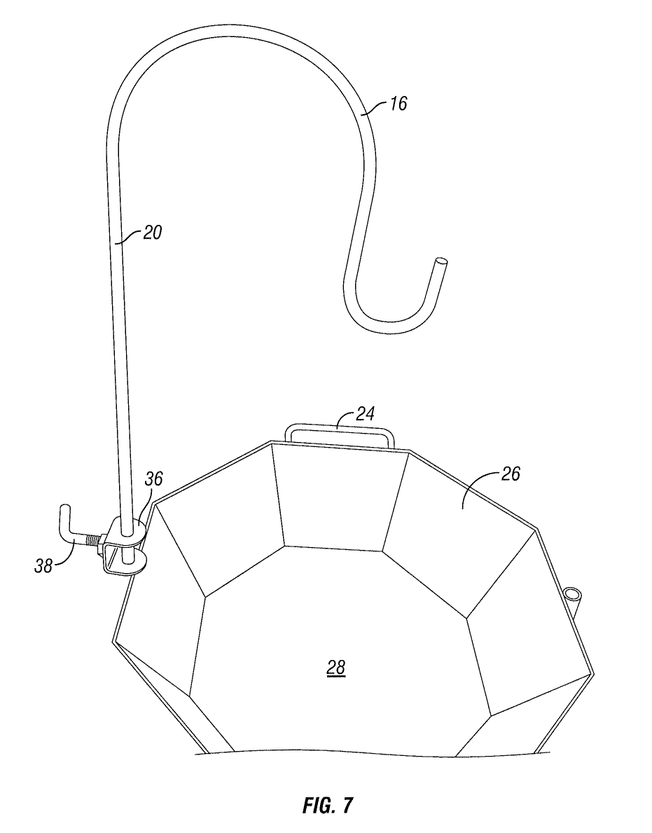

A second substantially vertically oriented tube can be attached to the fire pit illustratively opposite the first tube. The second tube may be configured to receive a hook 16, such as a Shepard's hook, that can suspend a pot or other cookware above the fire pit 12. Another lock bracket 36 may be attached to the Shepard's hook 16 with a set fastener 38 configured to selectively secure the lock bracket 36 to any desired position along the length of the hook 16 so as to adjust the hook's height above the fire pit (See FIGS. 6 and 7). In addition, the lock bracket 36 does not impede the hook's ability to pivot with respect to the fire pit 12. Just as with the cook surface, the hook 16 is pivotable both on and off the fire pit as well as any point in between. Also, like the cook surface, this may assist in affecting the amount of heat that is transferred from a fire in the fire pit to the pot and/or cookware suspending from the hook. For example, by moving either the cook top 14 or Shepard's hook 16 to be just partially over the fire pit 12, an indirect cooking opportunity is created. Heat may still be transferred by virtue of the portion of the cook surface or pot that is under the flame, but that heat is no longer direct.

In another illustrative embodiment, the cook top may be lowered so it is resting on the top edges of the fire pit. This may be useful to reduce the size of the fire pit 12 for use during sales, marketing and shipping purposes. In this embodiment, a hole 40 (FIGS. 2-3) may be formed in the base 28 of the fire pit 12 sized to receive the vertical post 18 depending from the cook top 14. The post 18 from the cook surface may then be inserted into the hole 40 in the base 28. In addition, in the illustrative embodiment, the Shepard's hook 16 may be sized to fit in the pan hole 40 as well. It is appreciated, that in some embodiments the tubes or holes in the fire pit 12 may all be the same size for the cook surface post 18 and the Shepard's hook 16. Or, the tubes and holes may be sized differently to accommodate a different diameter post on cook surface post than the diameter of the Shepard's hook.

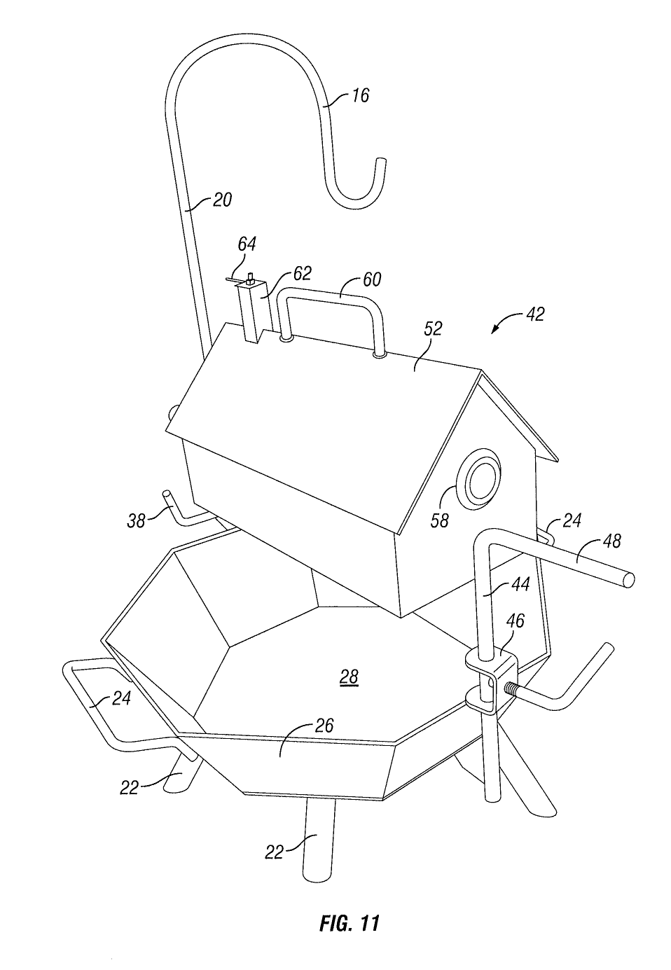

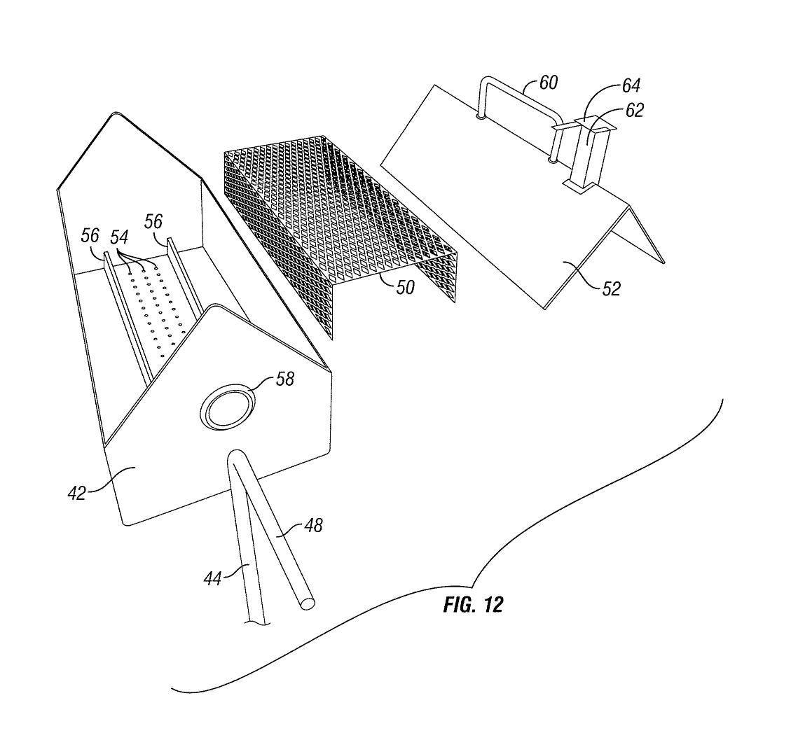

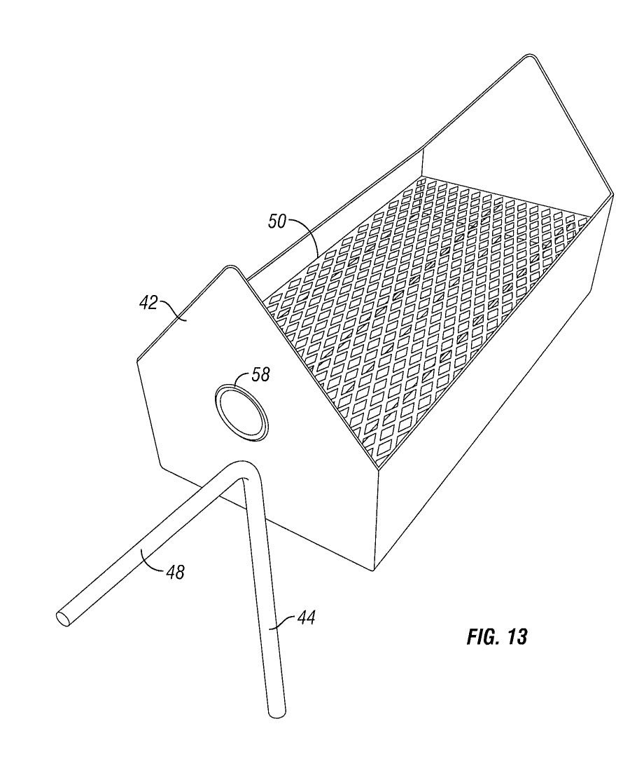

Another illustrative embodiment of the present disclosure shown in FIGS. 11-13 includes an adjustable smoker box 42 that is attachable to the cooker 10. Similar to how the aforementioned Shepard's hook 16 is attached via a second tube or opening on the cooker 10, the smoker box 42 may include a post 44, and an adjustable bracket 46 that fits in the tube so the smoker box 42 may be suspended above the fire pit 12. A handle 48 may also be used similar to the handle 34 on the cook top 14 to make moving the smoker box 42 more safe and convenient. The smoker box 42 may be selectively pivoted over top or away from the fire pit 12.

In addition to the post 44 and handle 48, the smoker box 42 includes the box itself supported on the post 44, a tray 50 that fits in the box 42, and a cover 52. The box 42 is illustratively sized and configured to hold food items to be smoked. There may be holes 54 formed in the bottom of the box to allow heat, air, and smoke to permeate from fire in the fire pit into the box 42. Walls 56 or supports such as the two longitudinally extending walls shown in the picture may be used to provide a space to hold moist wood or other smoking materials and even support the tray 50. It is also appreciated that in an embodiment, a thermometer 58 may be attached to the box 42 to monitor its temperature. The tray 50 such as the wire mesh tray shown fits in the smoker box above the walls 56. It is further appreciated that in various embodiments the tray 50 may be self-supporting such as the one shown or it may be set on the walls 56. The tray 50 is further configured to support the food products to be smoked. The cover 52 such as that shown is configured to fit over top the smoker box 42. This illustrative embodiment of the cover includes a handle 60 for convenient removal of the cover 52 to check the food products in the smoker box 42. Also, an illustrative embodiment may include a chimney 62 to provide an air out flow for the smoker. The chimney 62 may also include a cap 64 that is selectively movable to control the amount of air flow coming out through the smoker.

Although the present disclosure has been described with reference to particular means, materials and embodiments, from the foregoing description, one skilled in the art can easily ascertain the essential characteristics of the disclosure and various changes and modifications may be made to adapt the various uses and characteristics without departing from the spirit and scope of the disclosure.

What is claimed is:

1. An outdoor cooker comprising:
a fire pit standing on a plurality of legs, wherein the fire pit includes a first tube and a second tube, wherein the first tube and the second tube are axially offset with respect to each other;
a first cooking device including a post received in the first tube, wherein the first cooking device is movably suspended between a first position over the fire pit and a second position away from the fire pit; and
a second cooking device including a post received in the second tube, wherein the second cooking device is movably suspended between a third position over the fire pit and a fourth position away from the fire pit.

2. The outdoor cooker as recited in claim 1, further comprising a first bracket attached to the post of the first cooking device and configured to selectively attach along the post of the first cooking device to adjust a height of the first cooking device with respect to the fire pit.

3. The outdoor cooker as recited in claim 2, further comprising a second bracket attached to the post of the second cooking device and configured to selectively attach along the post of the second cooking device to adjust a height of the second cooking device with respect to the fire pit.

4. The outdoor cooker as recited in claim 3, wherein the first bracket includes a set fastener for selectively interacting with the post of the first cooking device.

5. The outdoor cooker as recited in claim 4, wherein the second bracket includes a set fastener for selectively interacting with the post of the second cooking device.

6. The outdoor cooker as recited in claim 5, wherein the first cooking device includes a handle that extends from the first cooking device transversely with respect to the post of the first cooking device.

7. The outdoor cooker as recited in claim 6, wherein the second cooking device includes a handle that extends from the second cooking device transversely with respect to the post of the second cooking device.

8. The outdoor cooker as recited in claim 7, wherein the first cooking device is pivotably movable about the first tube between the first position and the second position.

9. The outdoor cooker as recited in claim 8, wherein the second cooking device is pivotably movable about the second tube between the third position and the fourth position.

10. The outdoor cooker as recited in claim 9, wherein the first cooking device and the second cooking device pivot about axes that are offset from each other.

11. The outdoor cooker as recited in claim 10, wherein the first tube and the second tube are disposed on approximately opposite sides of the fire pit.

12. The outdoor cooker as recited in claim 10, wherein the first cooking device and the second cooking device are movable to approximately opposite sides of the fire pit.

13. The outdoor cooker as recited in claim 10, wherein the first cooking device is a cook top.

14. The outdoor cooker as recited in claim 13, wherein the cook top is one or more of a grill grate and a griddle.

15. The outdoor cooker as recited in claim 13, wherein the second cooking device is a Shepard's hook.

16. The outdoor cooker as recited in claim 13, wherein the second cooking device is a smoker box, wherein the smoker box includes a post pivotally connecting with the fire pit and a transversely extending handle.

17. An outdoor cooker comprising:
a fire pit standing on a plurality of legs;
a first cooking device pivotally connected with the fire pit between a first position over the fire pit and a second position away from the fire pit;
a second cooking device pivotally connected with the fire pit between a third position over the fire pit and a fourth position away from the fire pit; and
wherein the pivotal connection between the fire pit and the first cooking device is transversely offset from the pivotal connection between the fire pit and the second cooking device.

18. The outdoor cooker as recited in claim 17, wherein the pivotal connection between the fire pit and the first cooking device is positioned on an approximately opposite side of the fire pit as the pivotal connection between the fire pit and the second cooking device.

19. The outdoor cooker as recited in claim 18, wherein the first cooking device and the second cooking device are configured to simultaneously be disposed in the first position and the third position, respectively.

20. The outdoor cooker as recited in claim 19, wherein the first cooking device and the second cooking device are approximately coaxial with fire pit when in the first position and the third position, respectively.
